(19) United States
(12) Patent Application Publication
(10) Pub. No.: US 2015/0294328 A1
(43) Pub. Date: Oct. 15, 2015

(54) Customer Relationship Prediction and Valuation

(71) Applicant: BANK OF AMERICA CORPORATION, Charlotte, NC (US)

(72) Inventors: Jason Thalken, Austin, TX (US); Kang Jian, Princeton, NJ (US); Michael F. Petkus, Flower Mound, TX (US)

(73) Assignee: BANK OF AMERICA CORPORATION, Charlotte, NC (US)

(21) Appl. No.: 14/250,617

(22) Filed: Apr. 11, 2014

(51) Int. Cl. G06Q 30/02

(52) U.S. Cl. CPC G06Q 30/0202

(57) ABSTRACT

According to one embodiment of the present invention, a system stores a plurality of matrices. The system determines each relationship between a customer and an enterprise, wherein the enterprise comprises a plurality of customers having at least one relationship with the enterprise. The system generates a relationship flow matrix that includes customer relationship transitions with the enterprise during a first time period. The system calculates a probability of a change in the customer relationship with the enterprise according to a plurality of snapshots of the relationship flow matrices. The system generates a transition probability matrix based on the probability of the change in the customer relationship occurring. The system determines a current number of customers in each relationship with the enterprise. The system generates a current distribution matrix based on the current number of customers in each relationship with the enterprise. The system applies the transition probability matrix to the current distribution matrix. The system generates a future relationship matrix based on the application of the transition probability matrix to the current distribution matrix. The system applies the future relationship matrix to determine customer relationship value associated with the enterprise.

### TECHNICAL FIELD

This invention relates generally to customer data analysis, and more particularly to customer relationship prediction and valuation.

### BACKGROUND

Enterprises maintain various relationships with their customers. Relationships are constantly changing as customers open or close various types of accounts with the enterprise. Currently, predictions regarding the evolution of customer relationships and the valuations of those evolving relationships are limited.

### SUMMARY OF EXAMPLE EMBODIMENTS

In accordance with the present invention, disadvantages and problems associated with customer relationship prediction and valuation may be reduced or eliminated.

According to embodiments of the present disclosure, a system is operable to store a plurality of matrices. The system determines each relationship between a customer and an enterprise, wherein the enterprise comprises a plurality of customers having at least one relationship with the enterprise. The system generates a relationship flow matrix that includes customer relationship transitions with the enterprise during a first time period. The system calculates a probability of a change in the customer relationship with the enterprise according to a plurality of snapshots of the relationship flow matrices. The system generates a transition probability matrix based on the probability of the change in the customer relationship occurring. The system determines a current number of customers in each relationship with the enterprise. The system generates a current distribution matrix based on the current number of customers in each relationship with the enterprise. The system applies the transition probability matrix to the current distribution matrix and includes iterative application of the transition probability matrix to the current distribution matrix. The system generates a future relationship matrix based on the application of the transition probability matrix to the current distribution matrix. The system applies the future relationship matrix to determine customer relationship value.

Certain embodiments of the present disclosure may provide one or more technical advantages. A technical advantage of one embodiment includes the ability to predict the change in customer relationships over an extended time period through iterative application of a transition probability matrix, which can be modified by time or customer-related modifiers. Another technical advantage includes the ability to apply a value to a customer's relationship based on projected future relationship changes. Another technical advantage of an embodiment includes using historical relationship transition propensities to simulate the expected future relationship evolution for a given customer group, thus improving data prediction technologies. Yet another technical advantage includes the ability to run hypothetical scenarios and project them into the future to determine the impact on certain business decisions.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example of a system that facilitates customer relationship prediction and valuation;

FIG. 2 illustrates examples of stored relationship flow matrices and an example transition probability matrix; and

FIG. 3 illustrates an example flowchart for facilitating customer relationship prediction and valuation.

### DETAILED DESCRIPTION

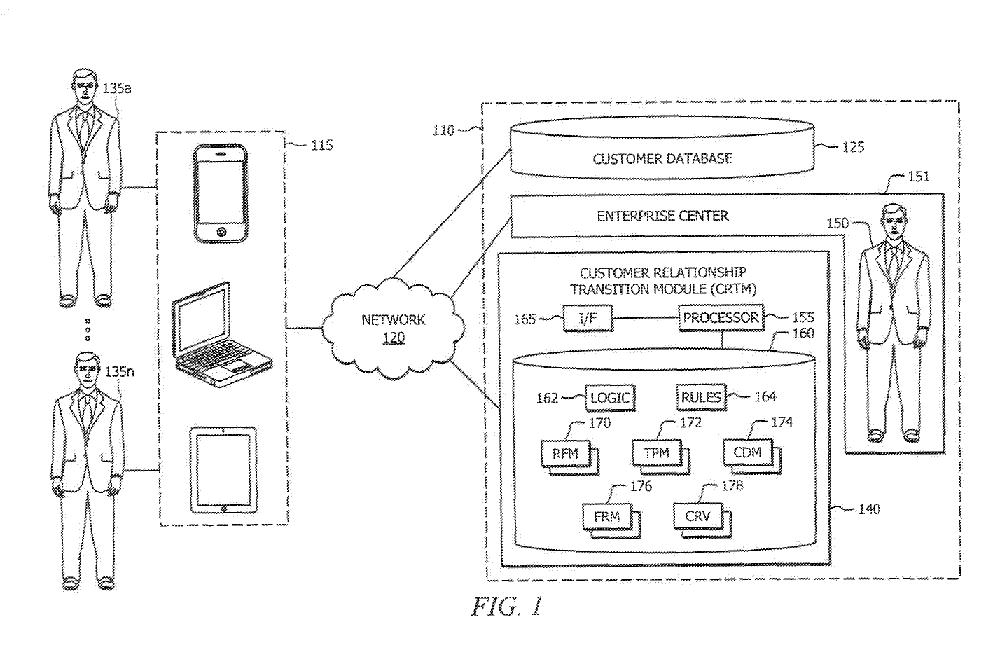

Embodiments of the present invention and its advantages are best understood by referring to FIGS. 1-3, like numerals being used for like and corresponding parts of the various drawings.

Banks, business enterprises, and other financial institutions that conduct transactions with customers may gather and analyze data regarding the various relationships a customer may have with the enterprise to determine how customer relationships transition. Examples of such relationships include, but are not limited to, a mortgage relationship, a deposit relationship, a card relationship, an installment relationship, an investment relationship, and a relationship involving any combination of the proceeding relationships. Typically, the information regarding a customer relationship is limited to a customer's current relationship with the bank. The teachings of this disclosure recognize that it would be desirable to predict the relationship of a customer across all products over time and to use that projection to value the current relationship with the customer.

FIG. 1 illustrates an example of a system 100 that facilitates customer relationship prediction and valuation. System 100 may include an enterprise 110, one or more customer devices 115, one or more enterprise centers 151, one or more enterprise associates 150, one or more customer databases 125, one or more Customer Relationship Transition Modules (CRTM) 140, and one or more customers 135. Enterprise 110 and customer devices 115 may be communicatively coupled by a network 120. Enterprise 110 is generally operable to engage in one or more relationships with one or more customers 135, as described below.

In general, CRTM 140 may receive customer relationship information to determine probabilities associated with changes in the customer relationship and, based on those probabilities, determine future relationship information and customer relationship value. CRTM 140 receives information from customer database 125, determines each relationship between customer 135 and enterprise 110, and generates relationship flow matrix 170 that includes customer relationship transitions with enterprise 110. CRTM 140 calculates a probability of a change in the customer relationship with enterprise 110 according to a plurality of snapshots of relationship flow matrices 170. CRTM 140 generates transition probability matrix 172 based on the probability of a change in the customer relationship occurring. CRTM 140 determines a current number of customers 135 in each relationship with enterprise 110 and generates a current distribution matrix 174 based on the current number of customers 135 in each relationship with enterprise 110. CRTM 140 applies transition probability matrix 172 to current distribution matrix 174 to generate future relationship matrix 176. CRTM 140 applies future relationship matrix 176 to determine customer relationship value 178 associated with enterprise 110. CRTM 140 communicates any of the generated matrices or customer relationship value 178 to enterprise associate 150 in response to a request.

Customer device 115 may refer to any device that facilitates customer 135 conducting a transaction with enterprise 110. In some embodiments, customer device 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Customer device 115 may also comprise any suitable user interface such as a display, microphone, keyboard, or any other appropriate terminal equipment usable by customer 135. It will be understood that system 100 may comprise any number and combination of customer devices 115. Customer 135 utilizes customer device 115 to interact with enterprise 110 and establish a new relationship with enterprise 110, as described below. In some embodiments, customer 135 may be a new customer of enterprise 110 attempting to conduct an activity, such as opening a banking account or applying for a credit card. In some embodiments, customer 135 may be an existing customer of enterprise 110 attempting to create a new relationship or terminate one or more relationships. Customer 135 may represent “n” number of customers ranging from customer 135a to customer 135n.

Network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

Enterprise 110 may refer to a financial institution, such as a bank, and may include one or more CRTMs 140, one or more customer databases 125, one or more enterprise centers 151, and one or more enterprise associates 150.

Customer database 125 represents any suitable device to store information about customers 135. In certain embodiments, the information about customers may include their current and past relationship or relationships with enterprise 110. Customer database 125 may also include information regarding the customer's name, home or work address, tenure with enterprise 110, income level, credit information, zip code, and most recent transaction or relationship history. In certain embodiments, CRTM 140 receives information from customer database 125 to determine the relationship between customer 135 and enterprise 110. In certain embodiments, CRTM 140 receives information from customer database 125 to determine the current number of customers in each relationship with enterprise 110. In certain embodiments, CRTM 140 receives information from customer database 125 to determine customer relationship value 178 for enterprise 110.

CRTM 140 may refer to any suitable combination of hardware and/or software implemented in one or more modules to process data and provide the described functions and operations. In some embodiments, the functions and operations described herein may be performed by a pool of CRTMs 140. In some embodiments, CRTM 140 may include, for example, a mainframe, server, host computer, workstation, web server, file server, a personal computer such as a laptop, or any other suitable device operable to process data. In some embodiments, CRTM 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, CRTM 140 receives information associated with customer 135 stored in customer database 125 to determine probabilities associated with changes in the customer relationship. Based on those probabilities, CRTM 140 determines future relationship matrices 176 and customer relationship value 178 for enterprise 110. In some embodiments, CRTM 140 may include a processor 155, memory 160, and an interface 165.

Memory 160 may refer to any suitable device capable of storing and facilitating retrieval of data and/or instructions. Examples of memory 160 include computer memory (for example, Random Access Memory (RAM) or Read Only Memory (ROM)), mass storage media (for example, a hard disk), removable storage media (for example, a Compact Disk (CI)) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates memory 160 as internal to CRTM 140, it should be understood that memory 160 may be internal or external to CRTM 140, depending on particular implementations. Also, memory 160 may be separate from or integral to other memory devices to achieve any suitable arrangement of memory devices for use in system 100.

Memory 160 is generally operable to store logic 162, rules 164, relationship flow matrix 170, transition probability matrix 172, current distribution matrix 174, future relationship matrix 176, and customer relationship value 178. Logic 162 generally refers to algorithms, code, tables, and/or other suitable instructions for performing the described functions and operations. Rules 164 generally refer to policies or directions for determining the type of customer relationship with enterprise 110, whether the probability of change in the customer relationship can be calculated, and the number of times to iteratively apply transition probability matrix 172 to generate future relationship matrix 176. Rules 164 may be predetermined or predefined, but may also be updated or amended based on the needs of enterprise 110. In certain embodiments, CRTM 140 generates one or more relationship flow matrices 170, transition probability matrices 172, current distribution matrices 174, future relationship matrices 176, and customer relationship value 178 and memory 160 stores this information.

Memory 160 communicatively couples to processor 155. Processor 155 is generally operable to execute logic 162 stored in memory 160 and to generate matrices according to the disclosure. Processor 155 may comprise any suitable combination of hardware and/or software implemented in one or more modules to execute instructions and manipulate data to perform the described functions for CRTM 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for CRTM 140, send output from CRTM 140, perform suitable processing of the input or output or both, communicate to other devices, or any combination of the preceding. Communication interface 165 may include appropriate hardware (e.g., modem, network interface card, etc.) and/or software, including protocol conversion and data processing capabilities, to communicate through network 120 or other communication system that allows CRTM 140 to communicate to other devices. Communication interface 165 may include any suitable software operable to access data from various devices such as customer devices 115 or customer databases 125. Communication interface 165 may also include any suitable software operable to transmit data to various devices such as customer devices 115. Communication interface 165 may include one or more ports, conversion software, or both. In general, communication interface 165 may receive relationship information from customer device 115 or customer database 125, receive a request to access a matrix by an enterprise associate 150, and communicate the requested matrix to enterprise associate 150.

In operation, logic 162 and rules 164, upon execution by processor 155, facilitate receiving information associated with customer 135 from customer database 125 to determine customer relationship value 178 associated with enterprise 110. Logic 162 and rules 164 also facilitate generating relationship flow matrix 170, transition probability matrix 172, current distribution matrix 174, future relationship matrix 176, and customer relationship value 178.

CRTM 140 may determine each relationship between customer 135 and enterprise 110. In some embodiments, CRTM 140 receives information associated with customer 135 from customer database 125 to determine the customer relationship. For example, customer database 125 may have information about a mortgage of customer 135 stored separately from information about a deposit account of customer 135. CRTM 140 may receive this information associated with customer 135 and determine that customer 135 has a mortgage+deposit relationship with enterprise 110. In certain embodiments, customer database 125 stores information associated with a plurality of customers 135 and CRTM 140 can determine each relationship of each customer 135.

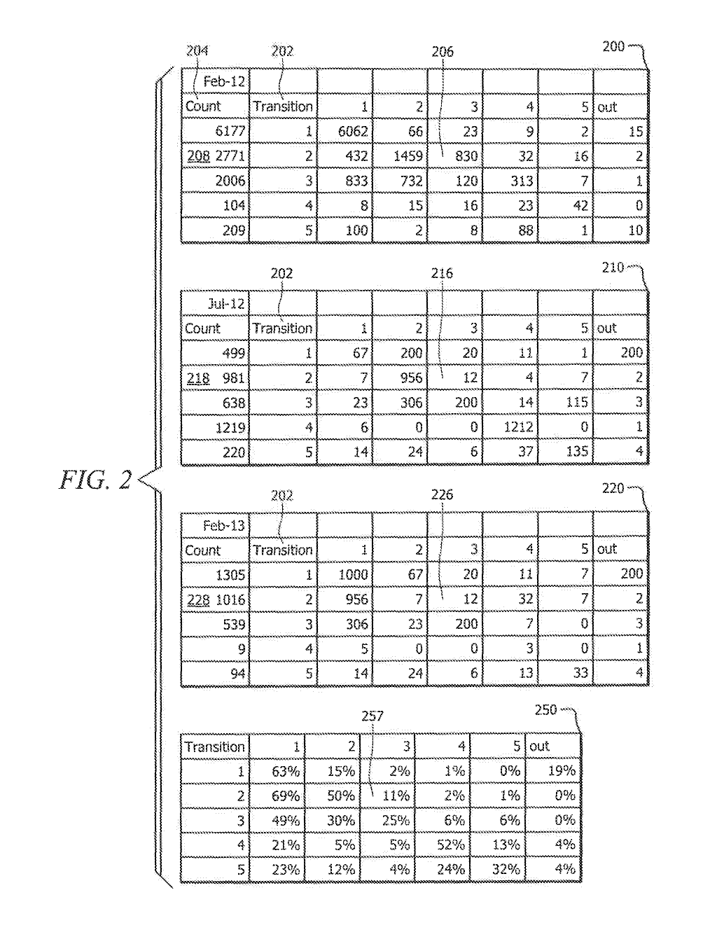

In some embodiments, CRTM 140 generates relationship flow matrix 170 that includes customer relationship transitions, which indicate how a customer's relationship with enterprise 110 may change. Relationship flow matrix 170 in certain embodiments includes a list of the types of possible customer relationships with enterprise 110. For example, relationship flow matrix 170 may list seven different types of relationships: mortgage only, deposit only, card only, mortgage+deposit, mortgage+card, deposit+card, and mortgage+deposit+card. Relationship flow matrix 170 displays a comparison of two consecutive time periods to capture the rate of movement from one relationship type to another. Relationship flow matrix 170 reflects the changes in customer relationships over a time period, such as one month. For example, relationship flow matrix 170 may list the various types of relationships on both of its axes. The cells at the intersection reflect the number of customers 135 that transitioned from the relationship on the x axis to the relationship on the y axis during that specific time period. For example, relationship flow matrix 170 may be created on May 1, 2012 to reflect the changes in customer relationships between Apr. 1, 2012 and Apr. 30, 2012. CRTM 140 may also store a snapshot of relationship flow matrix 170 in memory 160 on May 1, 2012. Examples of relationship flow matrices 170 are shown in FIG. 2.

In some embodiments, CRTM 140 determines whether the probability of change in the customer relationship can be calculated. For example, rules 164 may require a minimum number of snapshots of relationship flow matrix 170 to be used before CRTM 140 can calculate any probability of change. CRTM 140 may determine the number of stored snapshots of relationship flow matrix 170 and compare that to the minimum number required by the rules. As a particular example, if rules 164 establish that there must be at least 4 stored snapshots of relationship flow matrix 170 and CRTM 140 determines that there are only 3 stored snapshots of relationship flow matrix 170, then CRTM 140 does not calculate the probability of change in the customer relationship.

In some embodiments, rules 164 may require a minimum time period covered by stored snapshots of relationship flow matrix 170 before CRTM 140 can calculate any probability of change. For example, CRTM 140 may determine the time period between the first stored snapshot of relationship flow matrix 170 and the most recently stored snapshot of relationship flow matrix 170. Then, CRTM 140 may compare that time period with the time period required by rules 164 to determine whether CRTM 140 can calculate any probability of change. For example, if the first stored snapshot was created on May 1, 2012, reflecting the customer relationship changes during the month of April 2012, and the most recently stored snapshot was created on Jul. 1, 2012, reflecting the customer relationship changes during the month of June 2012, CRTM 140 determines a time period of two months between the two stored snapshots of relationship flow matrix 170. If rules 164 require a time period of six months or more, CRTM 140 determines that CRTM 140 cannot calculate any probability of change. In some embodiments, these requirements dictated by rules 164 may be decided by and entered into the system 100 by enterprise associate 150.

CRTM 140 may calculate the probability of a change from one customer relationship to another customer relationship. In some embodiments, CRTM 140 uses snapshots of relationship flow matrices 170 to calculate the probability of the relationship change. For example, CRTM 140 calculates the probability by retrieving a snapshot of relationship flow matrix 170, determining the number of customers 135 who switched from a mortgage only relationship to a mortgage+debit relationship over the time period for the snapshot, and comparing that number to the total number of customers 135 in a mortgage only relationship at the beginning of the time period. This comparison facilitates the determination of the percentage of customers that transitioned from one relationship to another. CRTM 140 then uses the plurality of percentages to calculate the probability of the change in relationship. For example, CRTM 140 may calculate the average of the percentages to determine the probability of the change in relationship. The probabilities may be calculated using any suitable technique, such as a simple average or a weighted average.

In some embodiments, CRTM 140 does not use all of the stored relationship flow matrices 170 to calculate a probability of change in a relationship. For example, CRTM 140 may select a stored snapshot of relationship flow matrix 170 on a certain date, and then select the next stored snapshots after a certain amount of time. CRTM 140 may select a stored snapshot of relationship flow matrix 170 on Feb. 1, 2012, then select the next stored snapshot of relationship flow matrix 170 on Jul. 1, 2012, and select the last stored snapshot of relationship flow matrix 170 on Feb. 1, 2013. CRTM 140 generates a transition probability matrix 172 based on the calculated probability of a change in the customer relationship occurring.

CRTM 140 may receive information associated with customer 135 from customer database 125 to determine the current number of customers 135 in each type of relationship with enterprise 110. In some embodiments, CRTM 140 may use information associated with the most recently stored relationship flow matrix 170 to determine the current number of customers 135 in each type of relationship with enterprise 110. CRTM 140 may generate current distribution matrix 174 based on the current number of customers 135 in each type of relationship with enterprise 110. CRTM 140 may also generate current distribution matrix 174 based on a hypothetical number of customers 135 in each type of relationship with enterprise 110. This hypothetical number of customers 135 allows enterprise 110 to determine customer relationship value 178 for different scenarios and compare them to assist enterprise 110 in forecasting, planning, and other analysis.

CRTM 140 generates future relationship matrix 176 based on the application of transition probability matrix 172 to current distribution matrix 174. Future relationship matrix 176 shows a prediction of the number of customers 135 in each relationship with enterprise 110 for a certain point in the future. In certain embodiments, relationship flow matrices 170 reflect the changes during a certain time period, and thus calculates transition probability matrix 172 comprising probabilities of change in a relationship over that certain time period. For example, if each relationship flow matrix 170 reflects the changes in customer relationships during a one month period, such as between Apr. 1, 2012, and Apr. 30, 2012, then CRTM 140 determines the probability of change in a relationship for one month. However, if enterprise 110 would like a prediction of the number of customers 135 in each relationship with enterprise 110 for 1 year in the future, CRTM 140 may apply transition probability matrix 176 iteratively. For example, CRTM 140 applies transition probability matrix 172 comprising probabilities of a change in relationship over one month to current distribution matrix 174. This creates future relationship matrix 176 comprising predicted customer relationship transitions one month in the future. To generate a future relationship matrix 176 for one year in the future, CRTM 140 may use the recently created future relationship matrix 176 and apply transition probability matrix 172 again, thus creating a future relationship matrix 176 showing the predicted number of customers 135 in each relationship with enterprise 110 two months in the future. This process continues until the desired future point in time is reached. Overall, using future relationship matrix 176, enterprise 110 is able to predict how many customers 135 will be in each relationship with enterprise 110 at a certain point in the future and determine the predicted relationship transitions of customer 135.

CRTM 140 applies the future relationship matrix 176 to determine customer relationship value 178 associated with the enterprise 110. For each iteration of transition probability matrix 172 to generate future relationship matrix 176, CRTM 140 also determines customer relationship value 178. For example, transition probability matrix 172 may reflect probabilities of a change in a customer relationship during a one month period. CRTM 140 may apply transition probability matrix 172 to current distribution matrix 174 to determine future relationship matrix 176 for one month in the future. To calculate customer relationship value 178, CRTM 140 may determine the predicted number of customers who add a mortgage relationship with enterprise 110 one month in the future and multiply this number of predicted customers by the first month shareholder value added. First month shareholder value added represents the one-time costs and revenues associated with onboarding a new account. CRTM 140 may also determine the predicted number of customers who had a mortgage relationship with enterprise 110 and will remain in a mortgage relationship one month in the future, and multiple this number of predicted customers by the ongoing monthly shareholder value added. The ongoing monthly shareholder value added represents the monthly net cash flow from that account. CRTM 140 may add these two numbers together to determine the customer relationship value 178 for mortgage relationships one month in the future. CRTM 140 repeats this process for each type of relationship a customer 135 may have with enterprise 110 to calculate a total revenue from the various customer relationships for one month into the future.

CRTM 140 may also take other factors into account when determining customer relationship value 178 including market size change, adjusted revenue, expected shareholder value added change, mortgage recapture rate, and annual mortgage payoff rate. CRTM 140 determines customer relationship value 178 for each iteration of future relationship matrix 176.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to the systems described herein without departing from the scope of the invention. For example, system 100 may include any number of customers 135, customer devices 115, networks 120, customer databases 125, CRTMs 140, and enterprises 110. As another example, particular functions, such as calculating the probability a change in the customer relationship will occur may be performed by a separate component and CRTM 140 receives the information regarding the transition probability matrix 172. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

FIG. 2 illustrates examples of stored relationship flow matrices 170 and one example of transition probability matrix 172. In certain embodiments, matrices 200, 210, and 220 are examples of relationship flow matrices 170. Example relationship flow matrix 200 shows the relationship transitions during the month of February 2012. Transition field 202 represents the type of relationships customer 135 may have with enterprise 110. For example, number 2 in transition field 202 may represent a mortgage only relationship, while number 3 in transition field 202 may represent a mortgage+deposit relationship. The y-axis transition fields represent the type of relationship a customer had at the beginning of the month, while the x-axis transition fields represent the type of relationship a customer had at the end of the month. The intersection of number 2 in the y-axis and number 3 in the x-axis, cell 206, represents the number of customers 135 who began the month of February 2012 as mortgage only and during the month added a deposit account, thus transitioning to a mortgage+deposit relationship. Count 204 represents the total number of customers 135 who started the month of February 2012 in the type of relationship listed on the y-axis. For example, cell 208 lists a count of 2771, which represents the total number of customers 135 that began the month with a mortgage only relationship. The sum of all the cells in row two, representing the relationship changes and transitions, will equal the count listed in cell 208. Similarly example relationship flow matrix 210 shows the relationship transitions during the month of July 2012, and example relationship flow matrix 220 shows the relationship transitions during the month of February 2013.

Example transition probability matrix 250 shows the probabilities that customer 135 will change from one type of relationship to another during a one month period. To calculate the probability of a change in example relationship flow matrix 200, CRTM 140 uses the proportion of cell 206 and cell 208 to determine the percentage of customers that transitioned from a mortgage only relationship to a mortgage+deposit relationship during February 2012. Similarly, CRTM 140 may use the proportion of cells 216 and 218 from example relationship flow matrix 210 and the proportion of cells 226 and 228 from example relationship flow matrix 220 to determine the percentage of customers that transitioned from a mortgage only relationship to a mortgage+deposit relationship during July 2012 and February 2013, respectively. In some embodiments, CRTM 140 averages the plurality of percentages to calculate the probability of the change in customer relationship. For example, cell 257 shows an 11% probability that customer 135 will move from relationship 2, a mortgage only relationship, to relationship 3, a mortgage+deposit relationship over a one month period. Cell 257 is calculated by determining the percentage of customers that transitioned from a mortgage only relationship to a mortgage+deposit relationship from each example relationship flow matrix 200, 210, and 220 and calculating the average of the percentages. As discussed above, the probabilities represented in transition probability matrix 250 may be calculated using any suitable technique, such as a simple average or a weighted average. These probabilities may also be generated by the results of other predictive models.

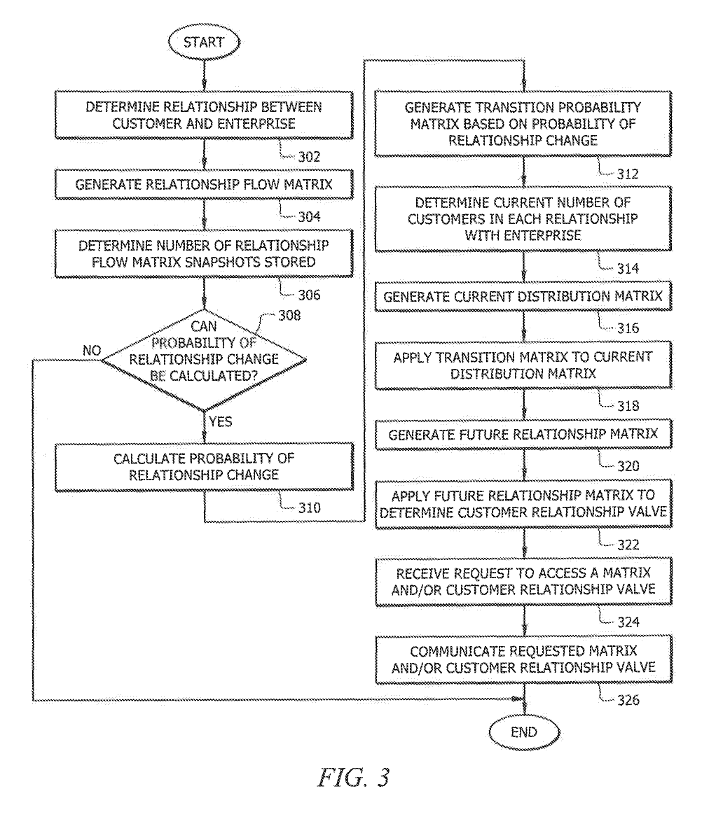

FIG. 3 illustrates an example flowchart for facilitating customer relationship prediction and valuation. The method begins at step 302 when CRTM 140 determines each relationship between customer 135 and enterprise 110, wherein enterprise 110 comprises a plurality of customers 135 having at least one relationship with the enterprise. Examples of relationships a customer may have with enterprise 110 include a mortgage relationship, a deposit relationship, a card relationship, an installment relationship, an investment relationship, any other suitable banking relationship, and/or any combination of the proceeding relationships.

At step 304, CRTM 140 generates relationship flow matrix 170 that includes customer relationship transitions with enterprise 110 during a time period. For example, one customer 135 may have a mortgage and card relationship, a second customer 135 may have a mortgage only relationship, and a third customer 135 may have a mortgage, card, deposit, and investment relationship. In some embodiments, relationship flow matrix 170 includes all of the various relationships customer 135 may have with enterprise 110 and the number of customers 135 who have transitioned from one type of relationship with enterprise 110 to another type of relationship with enterprise 110.

In step 306, CRTM 140 determines the number of stored snapshots of relationship flow matrix 170. In certain embodiments, the number of stored snapshots depends on how often CRTM 140 stores a snapshot of relationship flow matrix 170. In other embodiments, the method may proceed to step 308 without determining the number of stored snapshots. In step 308, CRTM 140 determines whether the probability of the change in the customer relationship can be calculated based on the number of stored snapshots and a time period. If CRTM 140 determines that the probability of the change in the customer relationship cannot be calculated, then the method ends. In certain embodiments, CRTM 140 may not determine the probability if the number of stored snapshots is below a certain number. For example, only two stored snapshots of relationship flow matrix 170 may not be sufficient to calculate an accurate probability of change in the customer relationship, so CRTM 140 determines the probability cannot be calculated. As another example, CRTM 140 may want to use snapshots of relationship flow matrix 170 that are a certain time period apart, such as a period of six months. For example, there may be one snapshot of relationship flow matrix 170 from May 1, 2012, and one snapshot from Jun. 1, 2012. If the time period between the earliest stored snapshot and the most recent stored snapshot is only one month, then in certain embodiments, CRTM 140 may determine the probability cannot be calculated. In certain embodiments, rules 164 may determine the requirements for CRTM 140 to calculate the probability of change.

If CRTM 140 determines in step 308 that the probability of the change in the customer relationship can be calculated, then CRTM 140 calculates a probability of a change in the customer relationship with enterprise 110 according to a plurality of snapshots of relationship flow matrices 170 in step 310. In certain embodiments, CRTM 140 may use any number of stored matrices between any number of time periods. For example, CRTM 140 may use three matrices—one stored on Jan. 1, 2012, reflecting the customer relationship changes in December 2011, a second stored on Jun. 1, 2012, reflecting the customer relationship changes in May 2012, and a third stored on Jan. 1, 2013, reflecting the customer relationship changes in December 2012—to determine the probability of a change in customer relationship. In certain embodiments, CRTM 140 may average data from the three snapshots to determine the probability of change over a one-month period. In step 312, CRTM 140 generates transition probability matrix 172 based on the probability of a change in the customer relationship occurring.

At step 314, CRTM 140 determines a current number of customers 135 in each relationship with enterprise 110. For example, CRTM 140 may determine that there are 1000 customers 135 in a mortgage only relationship, 2000 customers 135 in a card and deposit relationship, and 8000 customers 135 in a mortgage, card, and investment relationship. In certain embodiments, CRTM 140 may determine a hypothetical current number of customers 135 in each relationship with the enterprise. This may allow enterprise 110 to analyze or compare different scenarios. For example, if enterprise 110 was considering selling servicing rights to a particular group of mortgages, it could determine two different current number of customers 135: (1) the actual current number of customers 135 in each relationship, including all of those with mortgages in the group to be sold and (2) a hypothetical current number of customers that reflects enterprise 110 selling the mortgages and thus changing the relationship of those customers 135. This will allow enterprise 110 to determine the different future implications, including customer relationship transitions and customer relationship value 178, of selling the mortgages versus not selling the mortgages.

At step 316, CRTM 140 generates current distribution matrix 174 based on the current number of customers 135 in each relationship with the enterprise. In certain embodiments, current distribution matrix 174 may include an actual current number of customers 135 or a hypothetical current number of customers 135.

At step 318, CRTM 140 applies transition probability matrix 172 to current distribution matrix 174 to generate future relationship matrix 176 in step 320. In some embodiments, future relationship matrix 176 represents a prediction of the number of customers 135 in each relationship with enterprise 110 for a certain point in the future. In certain embodiments, CRTM 140 may store future relationship matrix 176 and compare this predicted data to actual future data to determine the reliability of the data. For example, on Oct. 3, 2013, CRTM 140 applies transition probability matrix 172 to current distribution matrix 174 iteratively to generate future relationship matrix 176 for five years in the future, or Oct. 3, 2018. On Oct. 3, 2018, CRTM may generate current distribution matrix 174 and compare it to the previously generated future relationship matrix 176 for Oct. 3, 2018. In certain embodiments, this allows CRTM to determine the accuracy of its probability of change calculations and to optimize the system.

At step 322, CRTM 140 applies future relationship matrix 176 to determine customer relationship value 178 associated with enterprise 110. With each iteration of future relationship matrix 176, CRTM 140 also determines customer relationship value 178. In determining customer relationship value 178, CRTM 140 may determine the predicted number of new customers in a certain type of relationship with enterprise 110 and the number of customers that were already in this certain type of relationship with enterprise 110 and are predicted to remain in that relationship. CRTM 140 may apply first month shareholder value added and ongoing monthly shareholder value added to determine a total revenue for that type of relationship for that time period in the future. This may be repeated with each iteration of future relationship matrix 176 to predict customer relationship value 178 for a point of time in the future.

At step 324, CRTM 140 receives a request from enterprise associate 150 to access relationship flow matrix 170, transition probability matrix 172, current distribution matrix 174, future relationship matrix 176, and/or customer relationship value 178. The method continues at step 326, when CRTM 140 communicates the requested relationship flow matrix 170, transition probability matrix 172, current distribution matrix 174, future relationship matrix 176, and/or customer relationship value 178 to enterprise associate 150. Using a previous example, enterprise associate 150 may request customer relationship value 178 based on the current distribution matrix 174 if enterprise 110 sold the mortgages and customer relationship value 178 based on the current distribution matrix 174 if enterprise 110 did not sell the mortgages. Enterprise associate 150, for example, may compare this information to make a business decision regarding enterprise 110. Then, the method ends.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for customer relationship prediction and valuation, comprising:
a memory operable to store a plurality of matrices; and
one or more processors communicatively coupled to the memory and operable to:
determine each relationship between a customer and an enterprise, wherein the enterprise comprises a plurality of customers having at least one relationship with the enterprise;
generate a relationship flow matrix that includes customer relationship transitions with the enterprise during a time period;
calculate a probability of a change in the customer relationship with the enterprise according to a plurality of snapshots of relationship flow matrices;
generate a transition probability matrix based on the probability of the change in the customer relationship occurring;
determine a current number of customers in each relationship with the enterprise;
generate a current distribution matrix based on the current number of customers in each relationship with the enterprise;
apply the transition probability matrix to the current distribution matrix;
generate a future relationship matrix based on the application of the transition probability matrix to the current distribution matrix; and
apply the future relationship matrix to determine a customer relationship value.

2. The system of claim 1, wherein generating the future relationship matrix comprises iteratively applying the transition probability matrix to the current distribution matrix.

3. The system of claim 1, the one or more processors further operable to:
determine a number of stored snapshots of the relationship flow matrix; and
determine whether the probability of the change in the customer relationship can be calculated based on the number of stored snapshots and a second time period.

4. The system of claim 1, wherein the relationship between the customer and the enterprise is a selected one of a mortgage relationship, a deposit relationship, a card relationship, an installment relationship, an investment relationship, and any combination of a preceding relationship.

5. The system of claim 1, wherein the current number of customers in each relationship with the enterprise is a hypothetical number of customers in each relationship with the enterprise.

6. The system of claim 1, further comprising an interface communicatively coupled to the memory and the one or more processors, the interface operable to:
receive a request from an associate to access at least one of the following: the relationship flow matrix, the transition probability matrix, the distribution matrix, the future relationship matrix, and the customer relationship value; and
communicate the selected at least one of the relationship flow matrix, the transition probability matrix, the distribution matrix, the future relationship matrix, and the customer relationship value to the associate.

7. A non-transitory computer readable storage medium comprising logic, the logic, when executed by a processor, operable to:
determine each relationship between a customer and an enterprise, wherein the enterprise comprises a plurality of customers having at least one relationship with the enterprise;
generate a relationship flow matrix that includes customer relationship transitions with the enterprise during a first time period;
calculate a probability of a change in the customer relationship with the enterprise according to a plurality of snapshots of relationship flow matrices;
generate a transition probability matrix based on the probability of the change in the customer relationship occurring;
determine a current number of customers in each relationship with the enterprise;
generate a current distribution matrix based on the current number of customers in each relationship with the enterprise;
apply the transition probability matrix to the current distribution matrix;
generate a future relationship matrix based on the application of the transition probability matrix to the current distribution matrix; and
apply the future relationship matrix to determine customer relationship value associated with the enterprise.

8. The computer readable storage medium of claim 7, wherein generating the future relationship matrix comprises iteratively applying the transition probability matrix to the current distribution matrix.

9. The computer readable storage medium of claim 7, the logic further operable to:
determine a number of stored snapshots of the relationship flow matrix; and
determine whether the probability of the change in the customer relationship can be calculated based on the number of stored snapshots and a second time period.

10. The computer readable storage medium of claim 7, wherein the relationship between the customer and the enterprise is a selected one of a mortgage relationship, a deposit relationship, a card relationship, an installment relationship, an investment relationship, and any combination of a preceding relationship.

11. The computer readable storage medium of claim 7, wherein the current number of customers in each relationship with the enterprise is a hypothetical number of customers in each relationship with the enterprise.

12. The computer readable storage medium of claim 7, the logic further operable to:
receive a request from an associate to access at least one of the following: the relationship flow matrix, the transition probability matrix, the distribution matrix, the future relationship matrix, and the customer relationship value; and
communicate the selected at least one of the relationship flow matrix, the transition probability matrix, the distribution matrix, the future relationship matrix, and the customer relationship value to the associate.

13. A method for customer relationship prediction and valuation, comprising:
determining each relationship between a customer and an enterprise, wherein the enterprise comprises a plurality of customers having at least one relationship with the enterprise;
generating, using a processor, a relationship flow matrix that includes customer relationship transitions with the enterprise during a first time period;
calculating, using a processor, a probability of a change in the customer relationship with the enterprise according to a plurality of snapshots of relationship flow matrices;
generating, using a processor, a transition probability matrix based on the probability of the change in the customer relationship occurring;
determining a current number of customers in each relationship with the enterprise;
generating, using a processor, a current distribution matrix based on the current number of customers in each relationship with the enterprise;
applying the transition probability matrix to the current distribution matrix;
generating a future relationship matrix based on the application of the transition probability matrix to the current distribution matrix; and
applying the future relationship matrix to determine customer relationship value.

14. The method of claim 13, wherein generating the future relationship matrix comprises iteratively applying the transition probability matrix to the current distribution matrix.

15. The method of claim 13, further comprising:
determining a number of stored snapshots of the relationship flow matrix; and
determining whether the probability of the change in the customer relationship can be calculated based on the number of stored snapshots and a time period.

16. The method of claim 13, wherein the relationship between the customer and the enterprise is a selected one of a mortgage relationship, a deposit relationship, a card relationship, an installment relationship, an investment relationship, and any combination of a preceding relationship.

17. The method of claim 13, wherein the current number of customers in each relationship with the enterprise is a hypothetical number of customers in each relationship with the enterprise.

18. The method of claim 13, further comprising:
receiving a request from an associate to access at least one of the following: the relationship flow matrix, the transition probability matrix, the distribution matrix, the future relationship matrix, and the customer relationship value; and
communicating the selected at least one of the relationship flow matrix, the transition probability matrix, the distribution matrix, the future relationship matrix, and the customer relationship value to the associate.
